(19) United States
(12) Patent Application Publication
(10) Pub. No.: US 2015/0224009 A1
(43) Pub. Date: Aug. 13, 2015

(54) ADJUSTABLE CINCH CLIP

(71) Applicant: Daniel P. Cedrone, Huntersville, NC (US)

(72) Inventor: Daniel P. Cedrone, Huntersville, NC (US)

(21) Appl. No.: 14/617,914

(22) Filed: Feb. 9, 2015

Related U.S. Application Data
(60) Provisional application No. 61/936,950, filed on Feb. 7, 2014.

(51) Int. Cl. A61G 13/12; F16M 13/04; F16L 3/13

(52) U.S. Cl. CPC A61G 13/1245; F16L 3/13; F16M 13/04; A61G 2200/50

(57) ABSTRACT

An adjustable cinch clip includes a clip unit that defines a support band opening for receiving a support band. The clip unit also defines a pinching channel substantially adjacent to the support band opening. The pinching channel is configured for frictionally securing the support band to the clip unit.

### CROSS-REFERENCE TO RELATED APPLICATIONS

The present application claims priority from provisional U.S. Patent Application No. 61/936,950 filed Feb. 7, 2014, the content of which is incorporated herein by reference in its entirety.

### FIELD OF THE INVENTION

The present disclosure relates to an adjustable cinch clip for securing a supporting band. The adjustable cinch clip may be use in connection with a belt and support band for supporting a leg. The disclosure further relates to an adjustable leg support.

### BACKGROUND

Persons suffering a leg injury are sometimes unable to bear weight on the injured leg. Pain or instability in the leg may prevent the person from bearing weight on the leg and/or the healing process may be promoted by eliminating or reducing the bearing of weight on the injured leg.

Typically, an ambulatory aid device such as a crutch(es), cane, or walker is used to assist the person in walking while allowing the person to avoid putting their weight on the injured leg. While these devices are effective at assisting with walking, they require the injured person to keep the injured leg suspended from the walking surface. Typically, the person bends the leg at the knee to keep the foot from touching the walking surface. Particularly in instances where the person is fitted with a cast, brace or other stabilizing device which tends to add weight to the injured leg, holding the leg in a position that keeps it from touching the walking surface can strain the person's muscles and interfere with proper body alignment. Furthermore, holding the leg in generally the same position in an effort to keep it from touching the walking surface generally does not exercise the person's leg muscles in a way that promotes healing.

Therefore, a need exists for an apparatus that allows a person having a leg injury to relax the injured leg while crutches or similar ambulatory aids are in use. In particular, a need exists for an adjustable support apparatus for a leg and an adjustable cinch clip for the adjustable support apparatus.

### SUMMARY

Accordingly, in one aspect, the present disclosure embraces an adjustable cinch clip. The adjustable cinch clip includes a clip unit. The clip unit defines (i) a support band opening for receiving a support band, and (ii) a pinching channel substantially adjacent to the support band opening for frictionally securing the support band to the clip unit.

In another embodiment, the clip unit defines a support band slot for receiving an end portion of the support band.

In yet another embodiment, the support band opening extends the entire length of the clip unit.

In yet another embodiment, the support band opening and the support band slot are substantially parallel and the support band slot is less than seventy-five percent of the length of the support band opening.

In yet another embodiment, the clip unit defines a belt opening for receiving a belt that is configured for securing about a user's waist.

In yet another embodiment, the support band opening is substantially cylindrical.

In yet another aspect, the present disclosure embraces an adjustable support apparatus for a leg. The adjustable support apparatus includes an adjustable belt for positioning around the waist of a user. The adjustable support apparatus also includes a clip unit defining a belt opening for receiving the belt. The adjustable support apparatus also includes a support band adjustably connected to the clip unit. The adjustable support apparatus also includes a connector attached to the support band for connecting the support band to a user's leg. The clip unit defines (i) a support band opening for receiving the support band, and (ii) a pinching channel substantially adjacent to said support band opening for frictionally securing the support band to said clip unit.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1 is a front perspective view of an adjustable cinch clip according to the present disclosure.

FIG. 2 is a top view of an adjustable cinch clip according to the present disclosure.

FIG. 3 is a bottom view of an adjustable cinch clip according to the present disclosure.

FIG. 4 is a front perspective view of an adjustable cinch clip according to the present disclosure having exemplary belt and support band secured thereto.

FIG. 5 is a front view of an adjustable support apparatus being worn by a user.

### DETAILED DESCRIPTION

The present disclosure embraces an adjustable cinch clip. The adjustable cinch clip may be used to secure a support band, rope, cord, ligature or similar elongated object. The cinch clip may be used for securing a support band to a belt. The cinch clip may also be used to adjust the length of the supporting section of the support band.

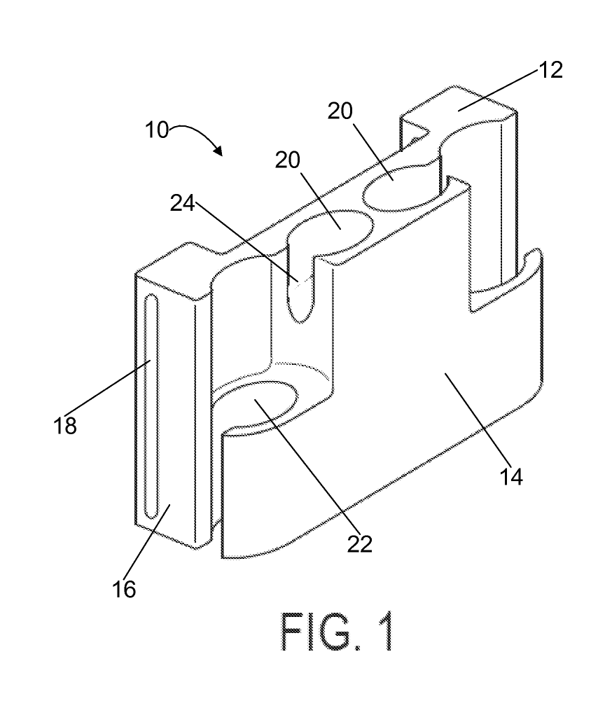

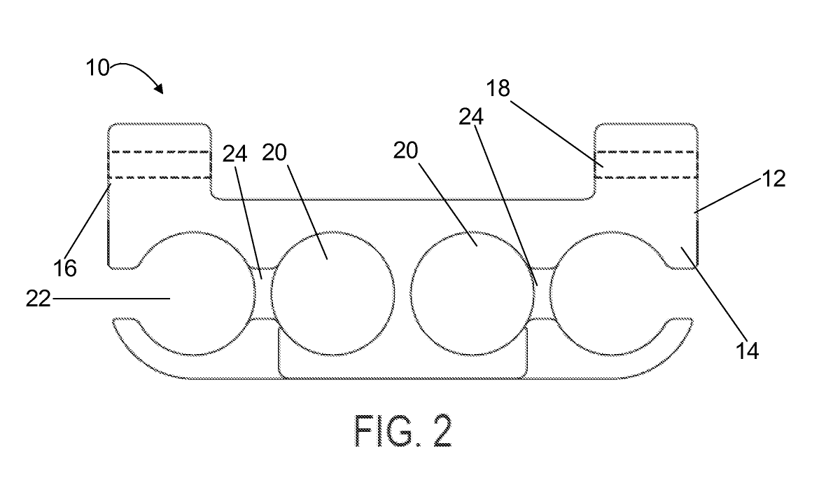

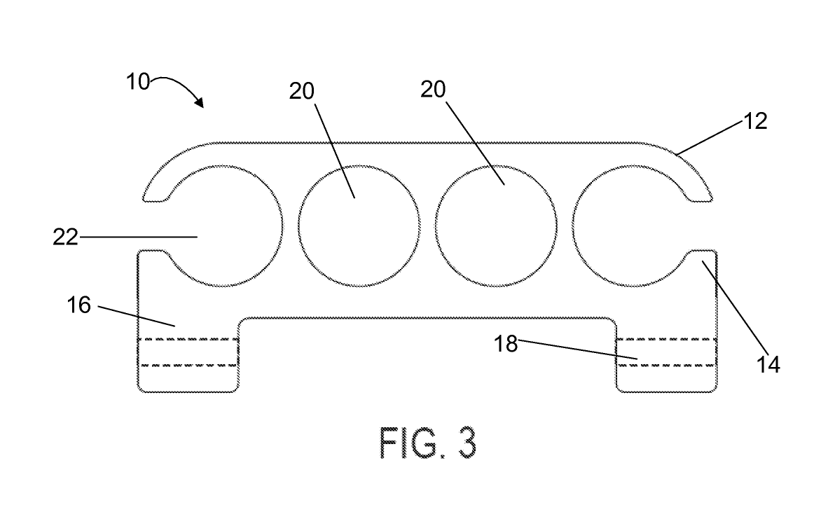

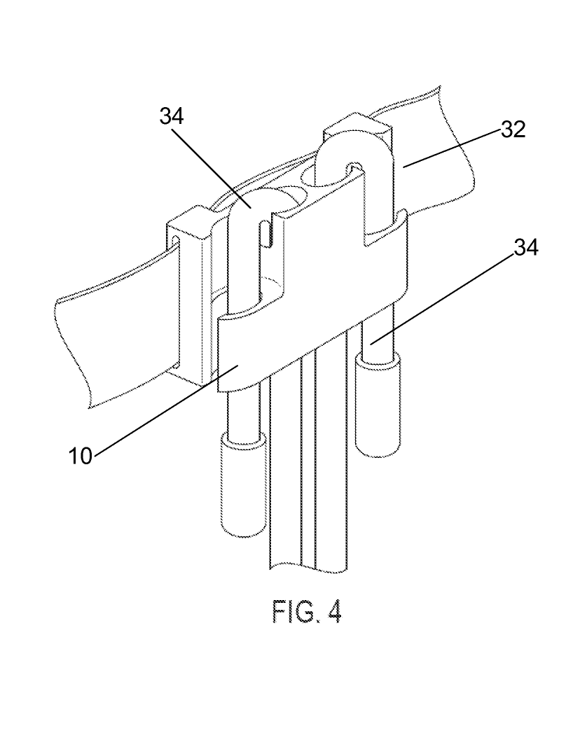

Referring now to FIGS. 1-4, and adjustable cinch clip 10 is shown. The adjustable cinch clip 10 is configured for use in connection with a belt (e.g., and adjustable belt) and a support band that supports a leg. The adjustable cinch clip 10 includes a clip unit 12. Typically, the clip unit 12 is substantially rectangular. The clip unit 12 may take a different shape. The clip unit 12 has a front portion 14 and a back portion 16.

The back portion 16 of the adjustable cinch clip 10 defines a belt opening 18 for receiving a belt. Typically, the belt opening 18 is vertically elongated. The belt opening 18 is configured to receive a belt for releasably attaching the clip unit 12 to the belt. Typically, the belt is slidably disposed within the belt opening 18 such that the position of the cinch clip 10 can be adjusted horizontally along the user's waist while the belt remains substantially in position around the user's waist.

The cinch clip 10 is not limited to use with a belt. In an alternative embodiment not pictured in the figures, in lieu of a belt opening, the clip unit 12 may include a connecting member for connecting the clip unit 12 to a surface. The connecting member may be integral with the clip unit 12, or it may be attached to the clip unit 12. The connecting member may comprise a fastener, an adhesive, a clamp a ligature, a magnet, a hook and loop fastener, or any other means suitable for attaching the clip unit to a surface. The surface may include a floor, a boat deck, a wall, a roof, footwear, or any other surface suitable for attachment to the adjustable cinch clip 10.

The clip unit 12 defines a support band opening 20. The support band opening 20 is configured for receiving a support band. The support band opening 20 typically extends the entire length of the clip unit such that a support band can be slidably inserted into one end of the clip unit 12 and withdrawn from other end of the clip unit 12. The clip unit 12 may define a plurality of support band openings 20. Typically, one of the plurality of support band openings 20 (e.g., a first support band opening) is configured to receive a first end portion of the support band. Typically, a different one of the plurality of support band openings 20 (e.g., a second support band opening) is configured to receive a second end portion of the support band. In other words, each of the support band openings 20 are configured to receive and end portion of the support band. Typically, each end portion of the support band is positioned inside a support band opening 20 such that part of the end portion extends out the top of the support band opening 20. The support band openings 20 are configured to allow the support band to slide through the support band openings. Typically, the support band openings 20 are generally circular (e.g., cylindrical), thereby facilitating their receipt of a support band, the body of which is typically substantially cylindrical.

It will be appreciated by a person of ordinary skill in the art that a support band may include any ligature-type elongated object. The disclosure is not limited to support bands configured to support a leg or other limb. For example, the adjustable cinch clip 10 according to the present disclosure may be configured to receive a rope, such as a marine rope located on a vessel or boat dock. In other words, the adjustable cinch clip may be used as a tie down (e.g., a cleat).

The clip unit 10 also defines a pinching channel 24. The pinching channel typically is substantially adjacent to (e.g., within a few millimeters of) the support band opening 20. The pinching channel 24 is configured for frictionally securing the support band to the clip unit 10. Typically, the pinching channel 25 is a v-channel (e.g., v-groove). To secure a support band to the adjustable cinch clip 10, the support band portion extending from, for example, the top of the support band opening is pulled into the pinching channel 25. The pinching channel 24 is of a sufficient size (e.g., having a diameter smaller than the diameter of the support band) to restrict the movement of the support band when the support band is forced into (e.g., squeezed inside) the pinching channel 24. The resulting compression force exerted by the pinching channel 24 on the support band portion within the pinching channel 24 prevents the support band portion from slidably dislodging from the adjustable cinch clip 10.

In one embodiment, the clip unit 10 defines a support band slot 22. The support band slot 22 is configured for receiving an end portion of the support band. For example, the free end portion (e.g., the end portion that is not connected to any other object) can be inserted into the support band slot 22. Inserting the free end portion into the support band slot 22 facilitates maintaining the support band within the pinching channel 24. In other words, to help prevent the free end portion of the support band from becoming dislodged from the pinching channel, the free end portion of the support band may be inserted into the support band slot 22. The support band slot 22 may be generally cylindrical thereby facilitating the receipt (e.g., insertion) of a portion of the support band.

In one embodiment, the support band opening 20 is substantially parallel to the support band slot 22. In this way, when a support band is inserted into the support band opening 20 in a first direction, the end of the support band can be pulled in an opposite, second direction, thereby facilitating the insertion of the support band into the pinching channel 24 and into the support band slot 22.

In this way the pinching channel 25 allows a user (or someone assisting the user) to adjust the length of the supporting portion of the support band. The supporting portion is that portion of the support band which extends from the bottom of the cinch clip 10 to connector 36. To shorten the length of the supporting portion of the support band, the user pulls the support band upwardly through the support band openings 20. To secure the support band at the desired position (e.g., with the desired supporting portion length), the user inserts an end portion of the supporting band into a pinching channel 24. The resulting friction lock secures prevents the support band from sliding out through the bottom of the cinch clip 10. Typically, the support band forms a loop, with each end portion of the support band being positioned through a support band opening 20 and secured in place by inserting the end portion of the support band into a pinching channel 24.

Typically, the support band openings 20 have a length (e.g., vertical height) that is greater than the length of the support band slots 22. In general, the length of the support band slots 22 is less than about seventy-five percent (e.g, between about forty percent and about seventy percent) of the length of the support band openings 20. The shorter height of the support band slots 22 facilitates the positioning of the support band end portions into the pinching channels 24 after passing them through the support band openings 20.

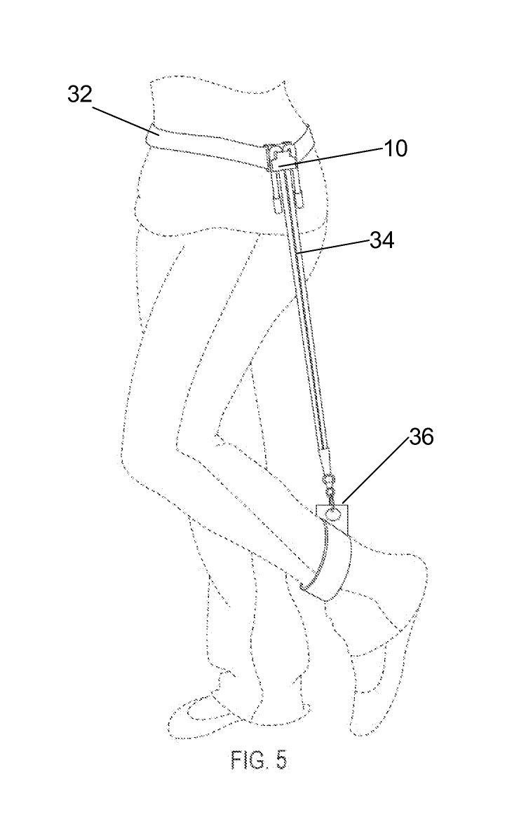

As shown in FIG. 5, the present disclosure also embraces an adjustable support apparatus 30 for a leg. The adjustable support apparatus 30 includes an adjustable belt 32. The adjustable belt 32 is configured for positioning (e.g., wearing) around the waist of a user. The adjustable support apparatus 30 also includes a clip unit 12 as described above. The adjustable belt 32 is attached to the clip unit 12.

The adjustable support unit also includes a support band 34. The support band 34 is adjustably connected to the clip unit 12. Typically, the support band 34 is a single, elongated band positioned with each end portion attached to the clip unit 12, thereby forming a loop extending downwardly (e.g., toward a user's leg when the apparatus is positioned on a user). The support band 34 may be formed of more than one constituent bands, however. Typically, the support band 34 is comprised of an elastic material (e.g., rubber, latex, etc.). This allows the support band 34 to stretch upon the application of a force to the support band 34, and then return to its original shape. The elastic nature of the support band 34 advantageously allows for a user to extend the injured, supported leg while meeting resistance generated by the resisting force of the support band 34. This affords the adjustable support apparatus 30 of the present disclosure the dual functionality of providing support and providing the capacity for resistance training to help strengthen the injured limb during the rehabilitation process.

The adjustable support apparatus also includes a connector 36. The connector 36 is attached to the support band 34. The connector 36 is configured for connecting the support band to the user's leg or other object to be supported by the adjustable support apparatus. The connector may include 36 a strap for positioning around a user's leg or other object to be supported. The connector may include a ring for allowing the strap to rotate in relation to the support band 34. The connector 36 may also include a ring for connecting to a walking boot or similar immobilizing device. The connector 36 may also include a brace, cast, walking boot, or other supporting or immobilizing device for positioning about a users leg.

In the specification and/or figures, typical embodiments of the invention have been disclosed. The present invention is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

1. An adjustable cinch clip, said clip comprising:
a clip unit defining (i) a support band opening for receiving a support band, and (ii) a pinching channel substantially adjacent to said support band opening for frictionally securing the support band to said clip unit.

2. The adjustable cinch clip of claim 1, wherein said clip unit defines a support band slot for receiving an end portion of the support band.

3. The adjustable cinch clip of claim 2, wherein said support band opening extends the entire length of the clip unit.

4. The adjustable cinch clip of claim 3, wherein:
said support band opening and said support band slot are substantially parallel;
said support band slot is less than seventy-five percent of the length of the support band opening.

5. The adjustable cinch clip of claim 1, wherein said clip unit defines a belt opening for receiving a belt configured for securing about a user's waist.

6. The adjustable cinch clip of claim 1, wherein said support band opening is substantially cylindrical.

7. An adjustable support apparatus for a leg, said apparatus comprising:
an adjustable belt for positioning around the waist of a user;
a clip unit defining a belt opening for receiving said belt;
a support band adjustably connected to said clip unit; and
a connector attached to said support band for connecting said support band to a user's leg;
wherein said clip unit defines (i) a support band opening for receiving the support band, and (ii) a pinching channel substantially adjacent to said support band opening for frictionally securing the support band to said clip unit.

8. The adjustable cinch clip of claim 7, wherein said clip unit defines a support band slot for receiving an end portion of the support band.

9. The adjustable cinch clip of claim 8, wherein said support band opening extends the entire length of the clip unit.

10. The adjustable cinch clip of claim 9, wherein:
said support band opening and said support band slot are substantially parallel;
said support band slot is less than seventy-five percent of the length of the support band opening.

11. The adjustable cinch clip of claim 7, wherein said clip unit defines a belt opening for receiving a belt configured for securing about a user's waist.

12. The adjustable cinch clip of claim 7, wherein said support band opening is substantially cylindrical.

13. The adjustable cinch clip of claim 7, wherein said support band comprises an elastic material.

14. The adjustable cinch clip of claim 7, wherein said support band comprises a rope.

15. The adjustable cinch clip of claim 7, wherein said connector comprises a strap for positioning around a user's leg.

16. The adjustable cinch clip of claim 7, wherein said connector comprises a ring for connecting to a walking boot.

17. An adjustable support apparatus for a leg, said apparatus comprising:
an adjustable belt for positioning around the waist of a user;
a clip unit defining a belt opening for receiving said belt;
a support band adjustably connected to said clip unit; and
a connector attached to said support band for connecting said support band to a user's leg;
wherein said clip unit defines (i) a support band opening for receiving the support band, (ii) a pinching channel substantially adjacent to said support band opening for frictionally securing the support band to said clip unit, (iii) a support band slot for receiving an end portion of the support band;
wherein said support band opening extends the entire length of the clip unit;
wherein said support band opening and said support band slot are substantially parallel; and
wherein said support band slot is less than seventy-five percent of the length of the support band opening.
